(19) United States
(12) Patent Application Publication
(10) Pub. No.: US 2008/0080871 A1
(43) Pub. Date: Apr. 3, 2008

(54) Slice level control

(75) Inventors: Jianguo Yao, Didcot (GB); Qi Pan, Didcot (GB); Joseph Barnard, London (GB)

Correspondence Address: SUGHRUE MION, PLLC, 2100 PENNSYLVANIA AVENUE, N.W., SUITE 800, WASHINGTON, DC, 20037, US

(73) Assignee: BOOKHAM TECHNOLOGY PLC

(21) Appl. No.: 11/540,612

(22) Filed: Oct. 2, 2006

(51) Int. Cl. H04B 10/00

(52) U.S. Cl. 398/164

(57) ABSTRACT

A method of processing an optical signal, including: generating one or more electrical signals indicative of said optical signal; applying said one or more electrical signals to one or more input pins of a chip configured to generate an output indicative of a comparison of the level of said one or more electrical signals with a reference level, the chip including circuitry configurable via two control pins to function as a DC offset cancellation loop; and applying across said two control pins a potential difference dependent on a characteristic of said optical signal so as to control said reference level in dependence on said characteristic of said optical signal.

### FIELD OF THE INVENTION

This invention relates to processing an optical signal, and in one embodiment to processing an optical signal in a pluggable module such as a small form factor pluggable (SFP) module or a 10 Gb/s small form factor pluggable (XFP) module.

### BACKGROUND OF THE INVENTION

Small form factor pluggable (SFP) modules and 10 Gb/s small form factor pluggable (XFP) modules are protocol independent optical transceivers used for a variety of optical communication systems. SFP modules are currently used at a data rate up to 2.488 Gb/s (OC48), but higher data rates, such as 5 Gb/s (½ OC192) or 8 Gb/s (8xFC), may also use this platform.

SFP and XFP modules operate both as optical transmitters and receivers. The modules take as input electrical communication signals and convert them for transmission down an optical fibre, and receive optical signals and produce electrical output signals. FIG. 1 illustrates the structure of the receive path of a typical SPF or XFP module 100. An optical signal 102 from an optical fibre is received at a receiver optical sub-assembly (ROSA) 104, which comprises a photodiode 106 connected to a trans-impedance amplifier (TIA) 108. The photodiode converts the optical signals from an optical fibre (not shown) to an electrical signal that is amplified by the TIA 108. The output of the ROSA 104 is differential electrical signals on lines 110 and 112. The differential electrical signals pass through AC coupling capacitors (114, 116) that are connected to the input of a limiting amplifier (LA) 118. The AC coupling capacitors (114, 116) remove any DC components from the differential signals before they are input to the LA 118.

It is desirable for the receiver to be able to control its slice level. The slice level (also called the decision threshold) is used when digitising electrical signals, and corresponds to the voltage level of the signal above which the module outputs a “high” level signal, and below which the module outputs a “low” level signal. For example, XFP and SFP modules could have high sensitivity even when receiving signals transmitted over long single mode (SM) fibres with low optical signal to noise ratios (OSNR) if the slice level can be adjusted to give lower bit errors.

### SUMMARY OF THE INVENTION

It is an aim of the present invention to provide a new technique by which the slice level of a module can be controlled.

According to the present invention there is provided, a method of processing an optical signal, including: generating one or more electrical signals indicative of said optical signal; applying said one or more electrical signals to one or more input pins of a chip configured to generate an output indicative of a comparison of the level of said one or more electrical signals with a reference level, the chip including circuitry configurable via two control pins to function as a DC offset cancellation loop; and applying across said two control pins a potential difference dependent on a characteristic of said optical signal so as to control said reference level in dependence on said characteristic of said optical signal.

Said characteristic of said optical signal could, for example, be the mean power or peak power of the optical signal, and said chip could, for example, be a limiting amplifier chip.

In one embodiment, said chip includes circuitry configured to function as a DC offset cancellation loop if a capacitor is connected between said two control pins.

According to another aspect of the present invention, there is provided a system for processing an optical signal, including: an optical detector unit configured to generate one or more electrical signals indicative of said optical signal; a chip arranged to receive said one or more electrical signals at one or more input pins thereof and configured to generate an output indicative of a comparison of the level of said one or more electrical signals with a reference level, the chip including circuitry configurable via two control pins to function as a DC offset cancellation loop; and a control unit configured to apply across said two control pins a potential difference dependent on a characteristic of said optical signal so as to control said reference level in dependence on said characteristic of said optical signal.

Said optical detector unit could, for example, include a photodiode and a trans-impedance amplifier.

According to another aspect of the present invention, there is provided a control unit for controlling the processing of an optical signal, wherein the control unit is configured to control in dependence on a characteristic of said optical signal the magnitude of a potential difference applied across two control pins of a chip for receiving at one or more input pins thereof one or more electrical signals indicative of said optical signal and generating an output indicative of a comparison of the level of said one or more electrical signals with a reference level, the chip including circuitry configurable via said two control pins to function as a DC offset cancellation loop.

According to another aspect of the present invention, there is provided a computer program product comprising program code means which when loaded into a computer controls the computer to carry out the step of claim 1 of controlling the potential difference across said two control pins of said chip in dependence on a characteristic of said optical signal. In one embodiment, the computer is a microprocessor/microcontroller and the code means is code (firmware) for loading to it.

According to another aspect of the present invention, there is provided a method of processing an optical signal, including: generating one or more electrical signals indicative of said optical signal; applying said one or more electrical signals to one or more input pins of a chip configured to generate an output indicative of a comparison of the level of said one or more electrical signals with a reference level, the chip including circuitry configurable via two control pins to function as a DC offset cancellation loop; and actively varying the potential difference across said two control pins in order to control said reference level.

### BRIEF DESCRIPTION OF THE DRAWINGS

For a better understanding of the present invention and to show how the same may be put into effect, reference will now be made, by way of example, to the following drawings in which:

FIG. 1 shows the structure of the receive path of a typical SPF or XFP module;

FIG. 2 shows a block diagram of an optical receiver with adaptive slice level control;

FIG. 3 shows a circuit for slice level control using a DC cancellation function of a limiting amplifier;

FIG. 4 shows a block diagram of a limiting amplifier with internal offset cancellation circuitry;

FIG. 5 shows an eye diagram of a receiver input optical signal with 50% crossing level;

FIG. 6 shows measured output crossing levels from + and − outputs of the limiting amplifier;

FIG. 7A-D show output eye diagrams of the receiver at slice control voltages of 2.28V, 2.29V, 2.30V and 2.31V;

FIG. 8 shows measured output signal crossing levels of the receiver with varying input optical power;

FIG. 9A-B shows eye diagrams of receiver input optical signals with 0 km and 120 km long single mode fibre;

FIG. 10 the measured bit error rate of the receiver module at an input optical power of −32 dBm;

FIG. 11A-B shows eye diagrams of receiver input optical signals with 0 km and 120 km long single mode fibre with SFP optical loop-back;

FIG. 12 shows the bit error rate of the receiver module in loop-back mode with a 0 km and 120 km single mode fibre;

FIG. 13 shows the measured sensitivity of the receive module with varying OSNR;

FIG. 14 shows the measured bit error rate of the receiver module at OSNR=16 dB with varying slice control voltage;

FIG. 15 shows the slice level control voltage versus input optical power;

FIG. 16 shows the measured bit error rate of the receiver module using adaptive slice level control at OSNR=25 dB;

FIG. 17 shows the measured bit error rate of the receiver module using adaptive slice level control at OSNR=16 dB;

FIG. 18 shows a block diagram of a slice level control circuit that measures the mean input power;

FIG. 19 shows an example of a current monitor circuit that can be used in an avalanche photodiode based optical receiver; and

FIG. 20 shows a block diagram of a peak input power based slice level control circuit.

### DESCRIPTION OF PREFERRED EMBODIMENTS

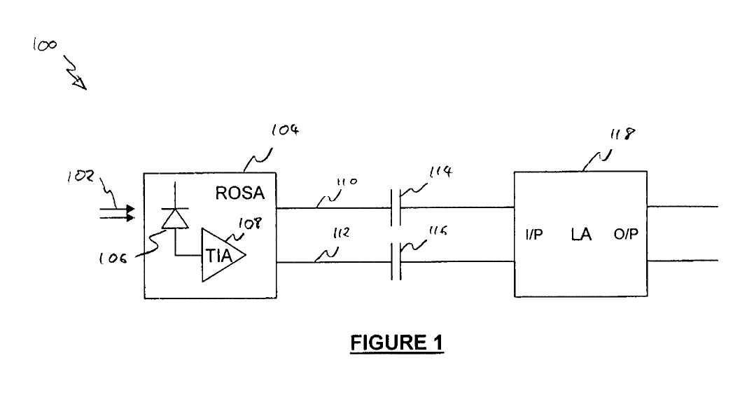

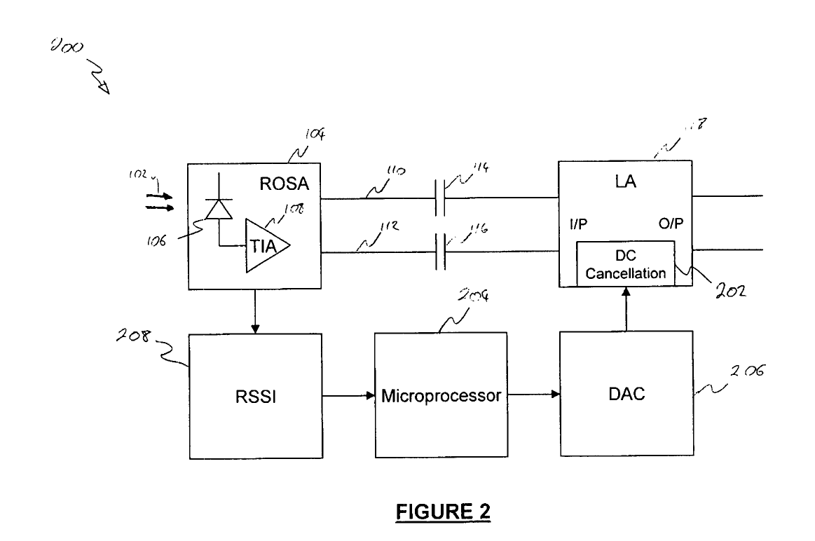

Reference is first made to FIG. 2, which illustrates a block diagram of an optical receiver 200 with adaptive slice level control. FIG. 2 shows a receiver optical sub-assembly 104, comprising a photodiode 106 connected to a trans-impedance amplifier 108, as shown previously in FIG. 1. As discussed above, the photodiode 106 receives optical signals 102 from an optical fibre (not shown) and these are converted to electrical signals that are amplified by the TIA 108. The output of the ROSA 104 is differential electrical signals on lines 110 and 112. AC coupling capacitors (112, 114) remove any DC components from the differential signals before they are input to the linear amplifier 118.

The limiting amplifier includes an internal DC cancellation circuit 202, which would normally be used to counteract any offset introduced at the input of the LA 118. However, in this embodiment of the present invention, this internal DC cancellation circuit is used instead to control the slice level (or decision threshold) of the LA 118, as will be described in more detail hereinbelow.

To optimise the slice level for different applications, such as a high dispersive link or a low signal OSNR, the slice level control is variable. The variable slice level control is achieved by using a microprocessor 204 and a digital to analogue converter (DAC) 206. The DAC 206 provides the required control voltage to the DC cancellation circuit 202 of the LA 118 and the microprocessor 204 can be programmed to manually or automatically compensate for slice level drift due, for example, to a change of temperature, input signal power, etc.

The slice level control can also be adaptive by utilising information about the input optical signal 102, such as amplitude or mean power. This information can be obtained via received signal strength indicator (RSSI) circuit 208. The RSSI can either be based on mean input power, or peak-to-peak swing. The RSSI circuit 208 provides the RSSI information to the microprocessor 204, which adjusts the slice level based on RSSI using intelligent control algorithms.

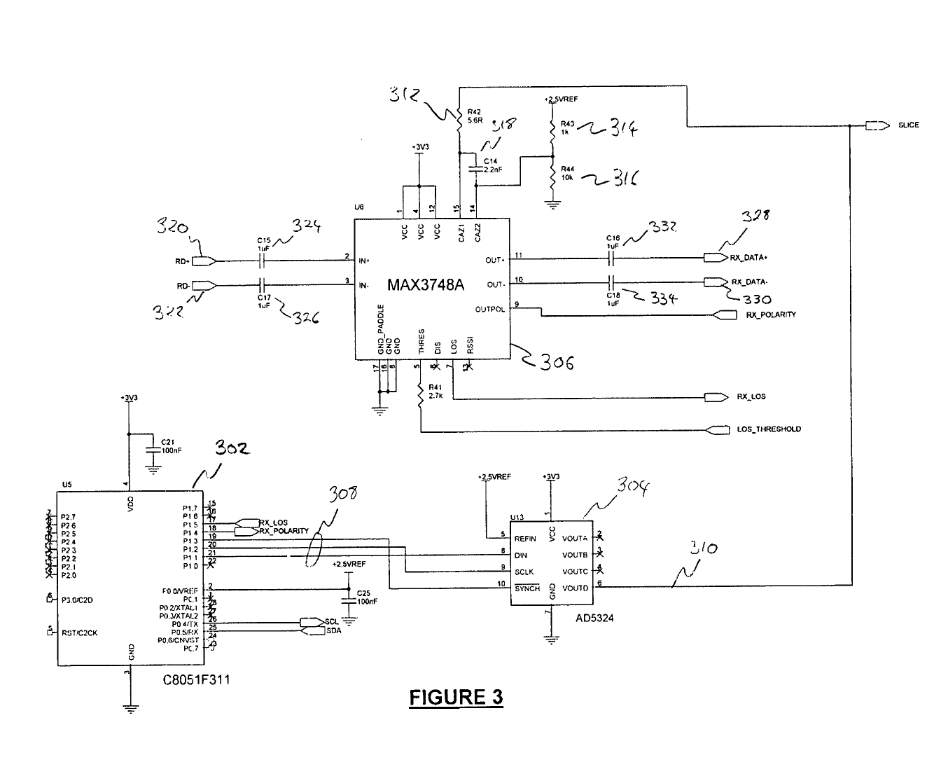

FIG. 3 illustrates an example circuit implementation of the microprocessor 204, DAC 206 and LA 118. In the example shown in FIG. 3, the microprocessor 302 is a C8051F311 manufactured by Silicon Laboratories, Inc, the DAC 304 is a 12-bit AD5324 manufactured by Analog Devices and the LA 306 is a MAX3748A manufactured by Maxim. The circuit can also be implemented using alternative devices.

The microprocessor 302 can control the DAC 304 using signals on lines 308, in order to set the magnitude of the output voltage of the DAC 304 on line 310. The output of the DAC 304 is connected to a first “offset correction loop capacitor connection” (CAZ1) pin of the LA 306 via resistor 312. The second “offset correction loop capacitor connection” (CAZ2) pin of the LA 306 is connected to a reference voltage provided by a potential divider formed of resistors 314 and 316. A capacitor is also connected between the CAZ1 and CAZ2 pins. The function of these two pins is discussed hereinafter.

The LA 306 receives differential input signals on inputs 320 and 322 via AC coupling capacitors 324 and 326 (as described above with reference to FIG. 1). The digitised differential output of the LA 306 is provided on outputs 328 and 330, via AC coupling capacitors 332 and 330.

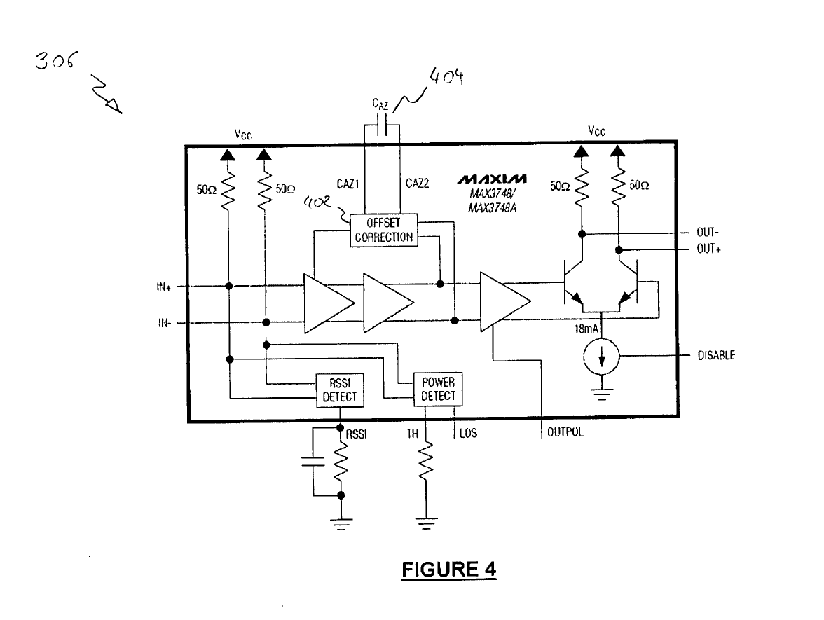

FIG. 4 shows a block diagram of a LA 306 with internal offset cancellation circuitry, such as the MAX3748A limiting amplifier. The internal cancellation circuit 402 is connected to the CAZ1 and CAZ2 pins. Conventionally, these U5 pins would be connected by nothing more than a capacitor 404 selected to set the time constant of the offset correction loop, such that the differential voltage between CAZ1 and CAZ2 would be close to 0V.

According to this embodiment of the present invention, the voltage difference between CAZ1 and CAZ2 is actively varied in order to vary the slice level of the LA 306. To simplify the circuit shown in FIG. 3 and save circuit board space, only one DAC is used to set the offset voltage to pin CAZ1, and pin CAZ2 is biased at a fixed voltage of approximately 2.27V.

Experiments have been designed and carried out to test the slice level control circuit described above. These tests verify that the receiver input signal slice level can be effectively adjusted using the control voltage from the DAC 304. The tests also demonstrate that there exists an optimum control voltage in variety of applications. The results of these tests are outlined below.

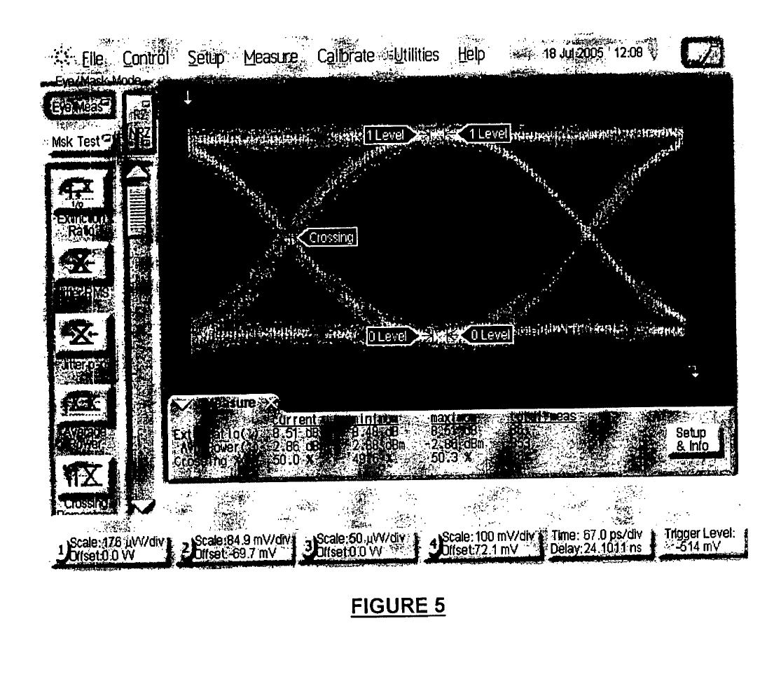

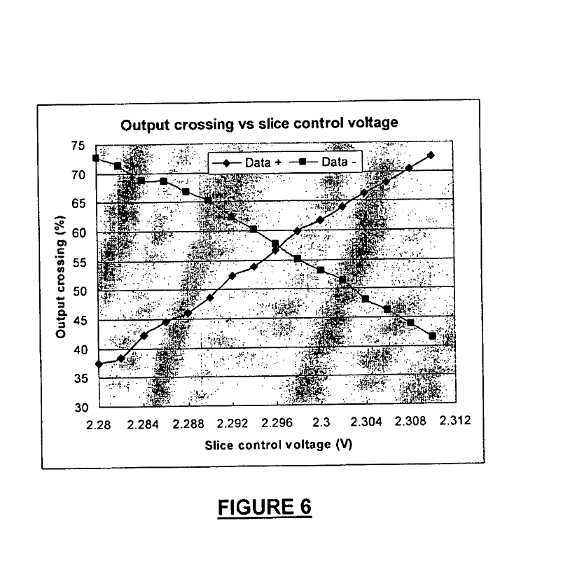

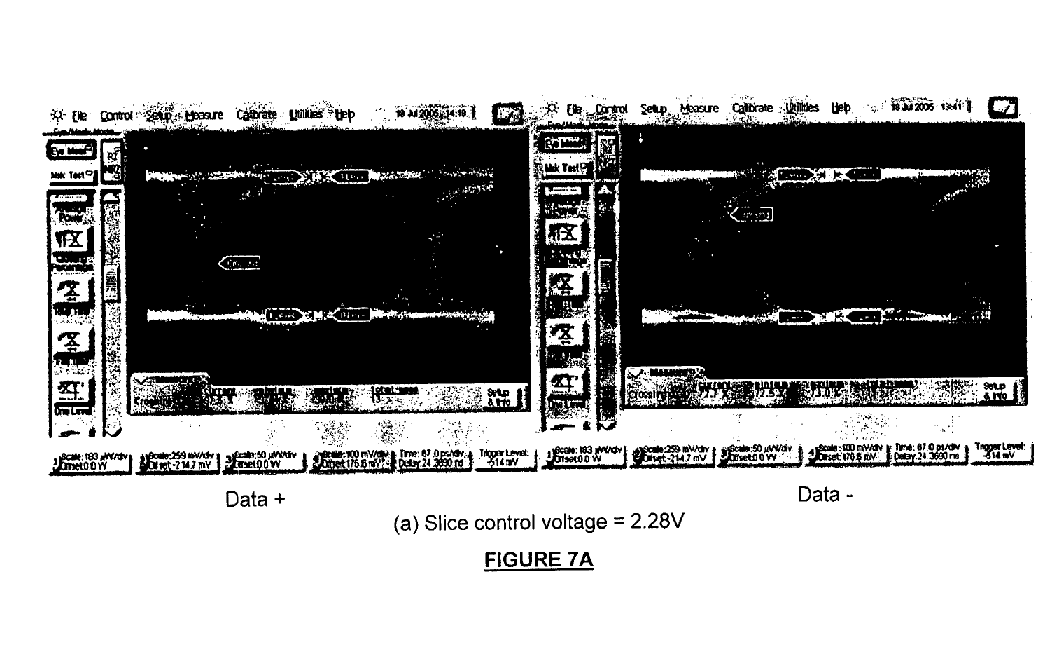

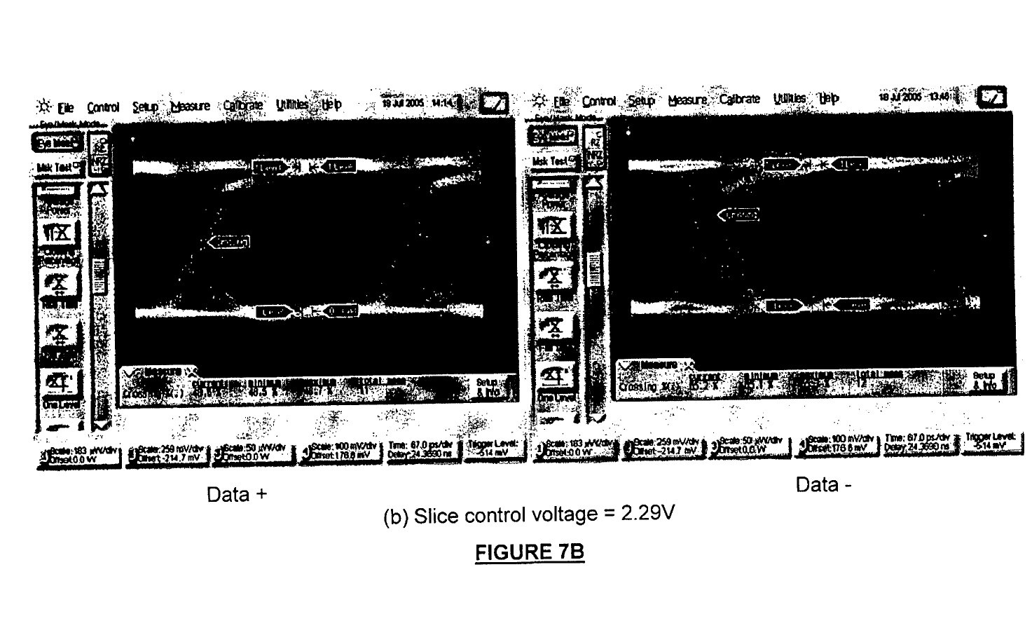

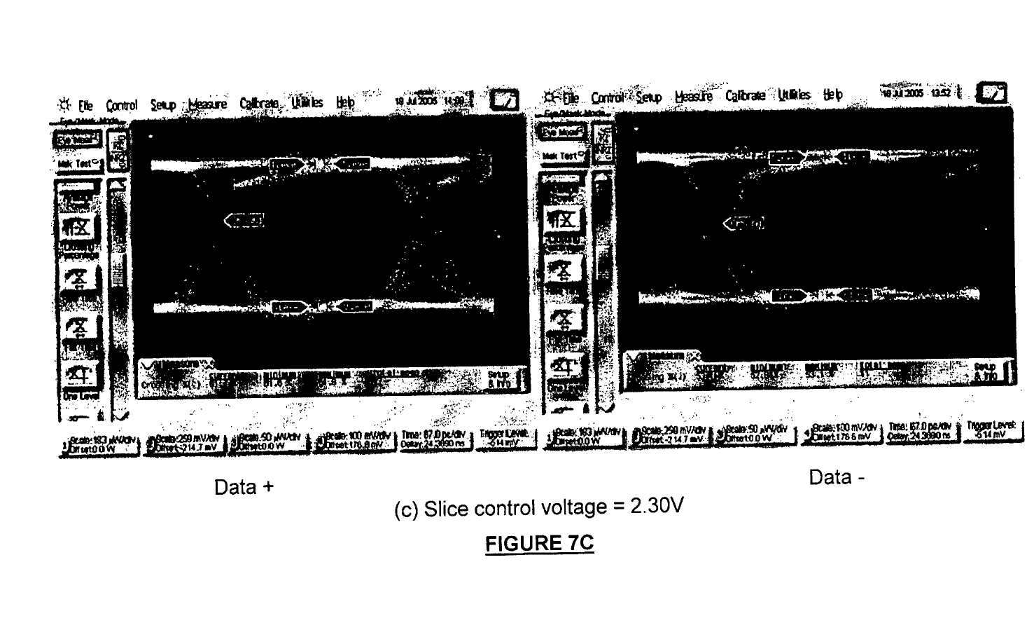

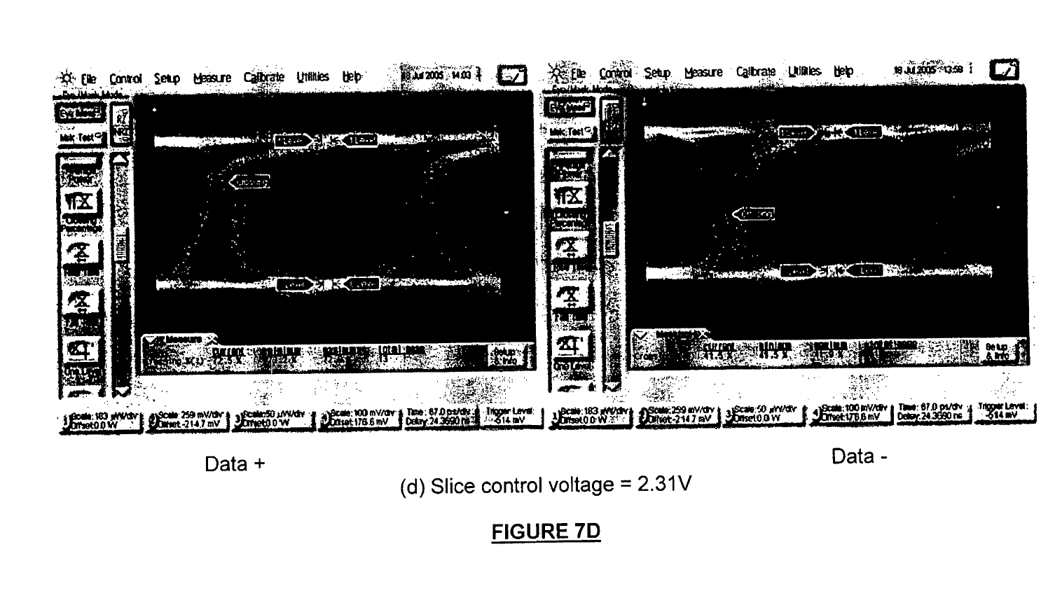

The change of receiver slice level (i.e. the decision level of the LA 306) is estimated by measuring the output crossing level of the limiting amplifier. The tests were performed using a 1550 nm BCP-420B transmitter to provide a modulated test signal to the receiver, and the crossing level was measured at the receiver output. Firstly, the input optical signal to the receiver was adjusted to give a 50% crossing as shown in the eye diagram illustrated in FIG. 5. The input optical power into the ROSA is −28 dBm. The measured output crossing from both data positive (data+328) and data negative (data−330) differential outputs is shown in the graph in FIG. 6. The measured output eye diagrams of the receiver at a slice control voltage of 2.28V, 2.29V, 2.30V and 2.31V are shown in FIGS. 7A-7D respectively. These test results show that the change of output signal crossing is approximately linear with changing slice level control voltage. The rate of change is approximately 1.05%/mV for positive output (data+) and 1.1%/mV for negative output (data−).

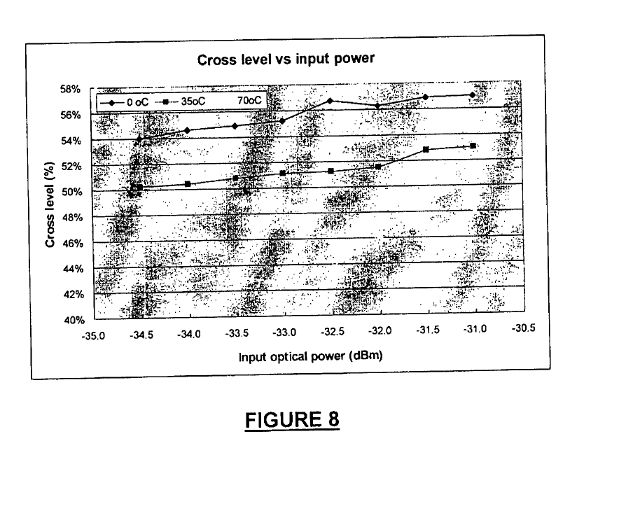

FIG. 8 shows the measured output signal crossing level of the receiver module with varying input optical power. The slice control voltage was fixed at 2.2981V. It is shown that with a fixed offset voltage between CAZ1 and CAZ2 the slice level of the LA 306 changes slightly with input signal amplitude at power range of −31 dBm to −34.5 dBm. It also changes with device temperature. At 0° C. and 25° C. case temperature the output crossing level increases by around 3% when the input optical power is increased by 3.5 dB. The increasing of crossing level for the same input power range is higher (5%) at 70° C. This can be caused by inaccuracy of the temperature compensation in the avalanche photo diode (APD) bias voltage. The APD gain may be higher at 70° C. compare with the gain at 0° C. and 35° C. The increase in APD gain causes an increase in ROSA output amplitude for the same input optical power; hence the crossing of the output signal is further away from centre of the eye.

The change of crossing level with temperature can be compensated by adding a temperature coefficient into the slice control algorithm. A three point calibration can be used to set the temperature coefficient during set up stage of the module. The change of slice level with input power can be achieved using the adaptive slice level control circuit described with reference to FIG. 2, and described in more detail hereinafter.

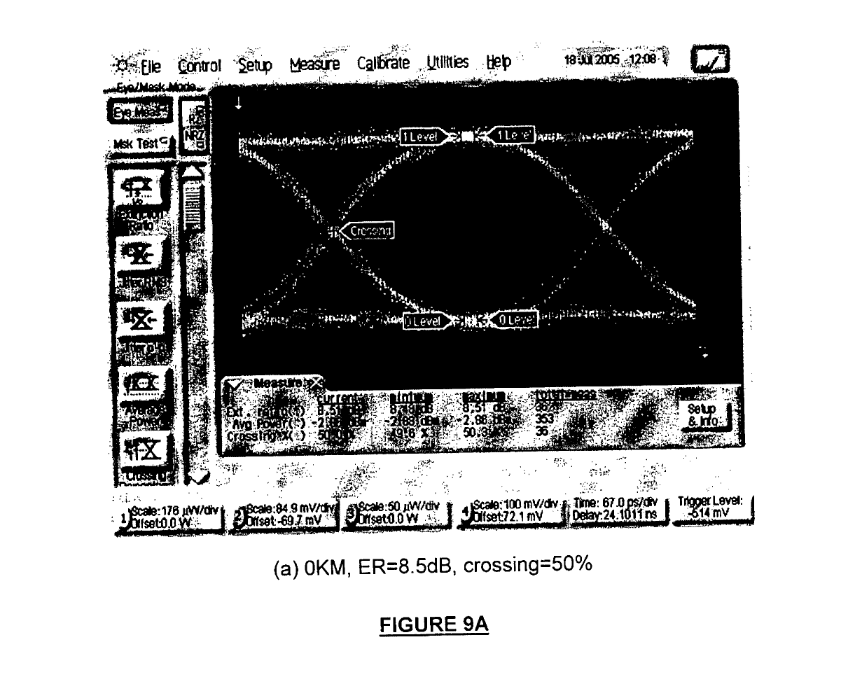

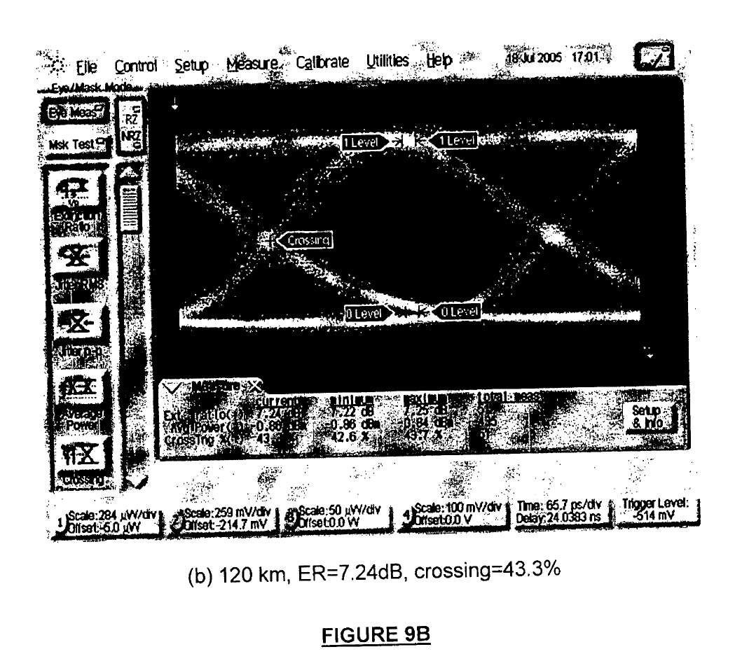

As mentioned previously, one of the main functions of the slice level control is to optimise the receiver sensitivity in a highly dispersive application (such as a long fibre) where the input signal eye centre is shifted away from the centre (50%). FIG. 9A-B shows the eye diagram from a 1550 nm BCP-420B optical transmitter with 0 km (FIG. 9A) and 120 km (FIG. 9B) long single mode (SM) fibre. The crossing level of the transmitter is adjusted to 50% at 0 km. Note, however, that the crossing level has dropped to 43% with 120 km of SM fibre.

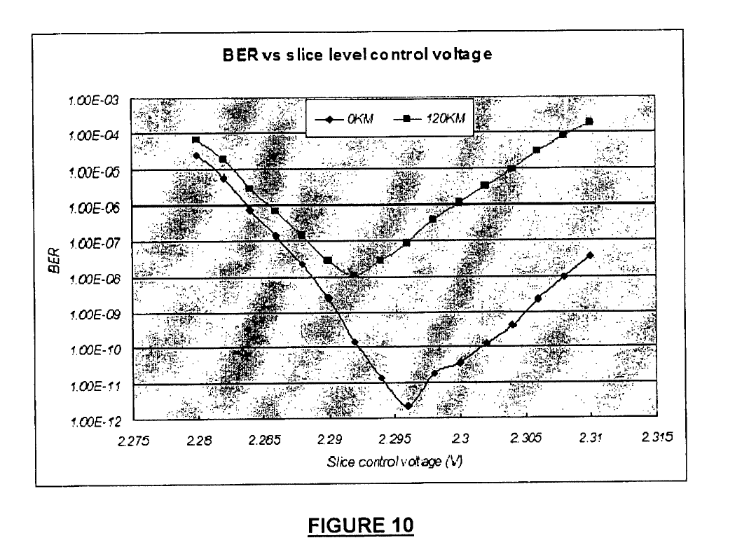

FIG. 10 shows the measured bit error rate (BER) of the receiver module at an input optical power of −32 dBm. This clearly shows that with 0 km of fibre the optimum slice control voltage (i.e. lowest BER) is around 2.297V. However with a 120 km long fibre the optimum slice control voltage (i.e. lowest BER) is shifted to around 2.293V.

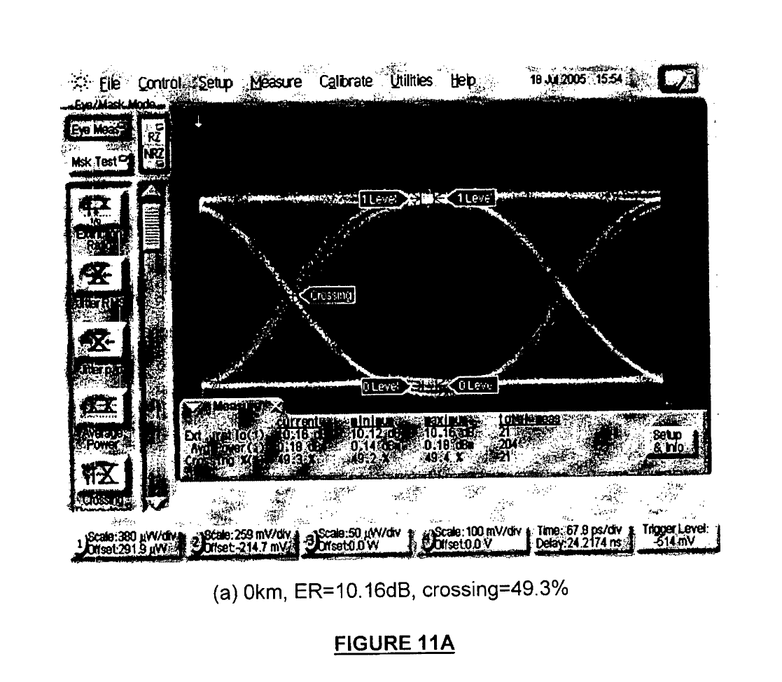

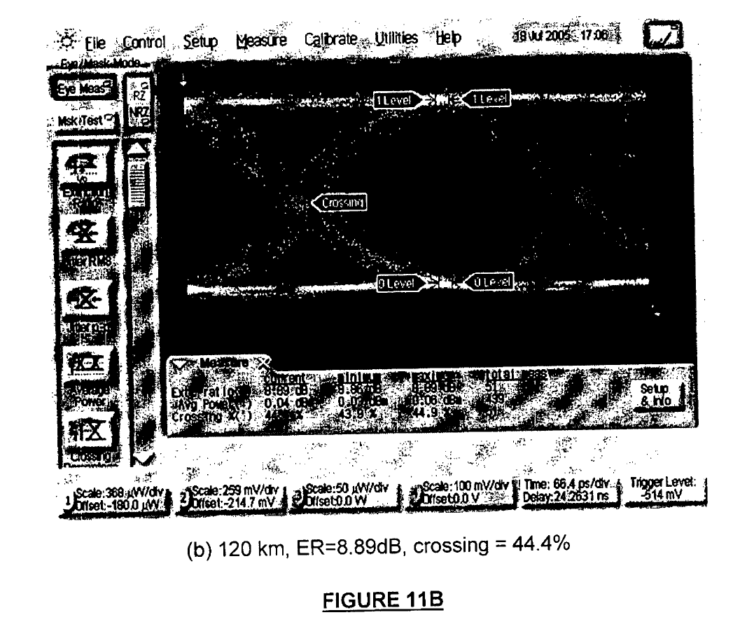

FIG. 11 shows results for an alternative test set up in which the SFP module is looped back optically so the transmitter output from the module is connected to the optical receiver of the same module. FIG. 11A shows the transmitted optical eye for a 0 km fibre, and FIG. 11B shows the transmitted optical eye after a 120 km fibre. Because the optical transmitter inside the module has lower chirp than the BCP-420 transmitter the eye crossing after 120 km is slightly higher (44.4%) than the BCP transmitter (43.3%).

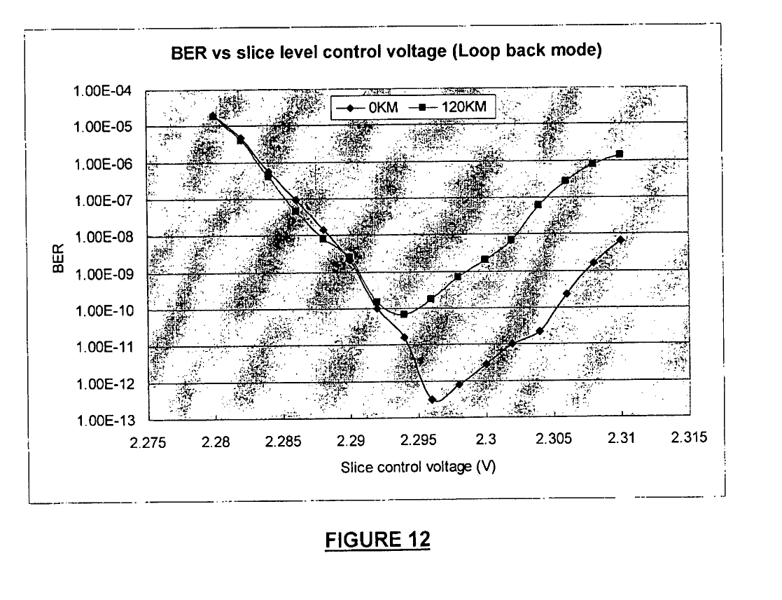

FIG. 12 shows the BER of the receiver module in loop-back mode with a 0 km and 120 km SM fibre. Again, the optimum slice control voltage with 0 km fibre is higher than that with 120 km fibre. However, the wavelength chirp of the transmitter optical sub-assembly (TOSA) used in the SFP module is lower than that of the commercial bench top transmitter (BCP-420B), hence the difference in optimum slice voltage between 0 Km and 120 km is smaller than that shown in FIG. 10.

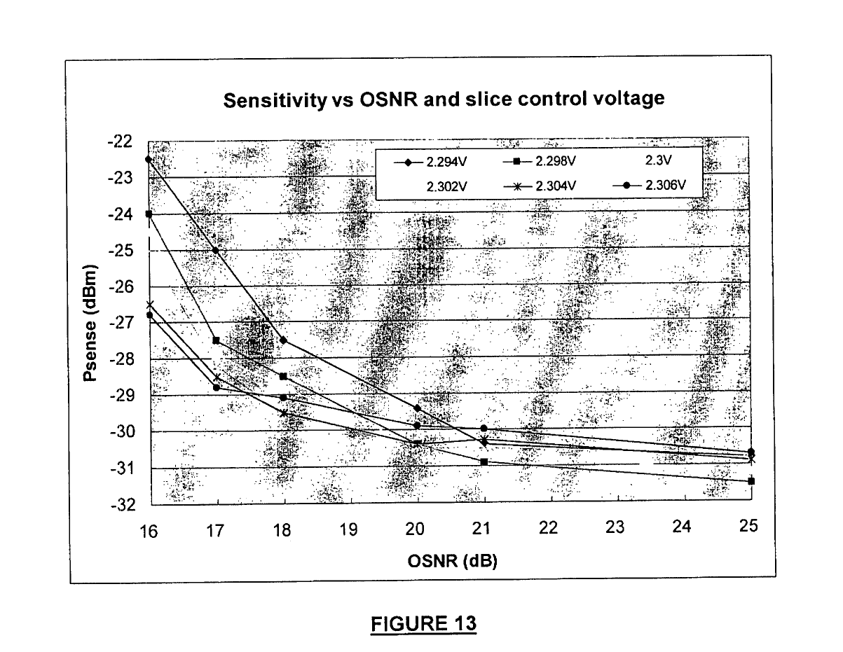

Apart from the fibre dispersion over long fibres which will cause the input signal eye centre to move away from the middle point, the addition of optical noise, mostly introduced when the signal passes through an optical amplifier, will also drive the optimum decision point away from the middle of the signal amplitude (50%). This is illustrated in FIG. 13, which shows the measured sensitivity of the receive module with varying OSNR. The test result shows that with low optical noise (OSNR=25 dB) the optimum slice control voltage is around 2.298V. However, when the OSNR is reduced to 16 dB the optimum slice voltage is increased to 2.306V (an 8 mV increase).

FIG. 14 illustrates the measured BER of the receiver module at OSNR=16 dB with varying slice control voltage. As mentioned above with reference to FIG. 13, the optimum slice control voltage for high OSNR and 0 km fibre is around 2.298V. The measured sensitivity with a fixed slice voltage optimised for high OSNR (2.298V) gives a poor sensitivity (−22 dBm) at low OSNR (16 dB) and a noise floor for input powers above −15 dBm. Increasing the slice voltage to 2.302V improves the sensitivity from −22 dBm to −27 dBm, but the noise floor at input power above −15 dBm is still present. To remove the noise floor at higher input power, the slice control voltage has to be increased by at least 50-100 mV. However the sensitivity drops significantly at higher slice levels.

The above-described experimental results show that the optimum slice level for different operating conditions varies significantly. Hence, an automatic or adaptive slice level control is required. The measurement results show that the optimum slice control voltage for greatest sensitivity with high optical noise and high dispersion are about ±4 mV from the optimum voltage with a ‘clean’ input signal. However, the optimum slice control voltage at high input signals needs to be 50-100 mV above the one optimised for low signal level.

The equation below shows an algorithm used in an adaptive slice level control scheme to give a small change in slice level at low signal levels but a much greater change in slice level at a high input signal level:

V_{slice}=Vₛₘₐₗₗ+K(Pᵢₙ/P_{cal}−1)

Where V_{slice} is the slice level control voltage, Vₛₘₐₗₗ is the optimum slice level control voltage for small signal, K is a scaling factor, Pᵢₙ is the input optical power, P_{cal} is the input optical power at calibration. P_{cal} correspond to the input optical power for a small signal (i.e. when Vₛₘₐₗₗ is measured).

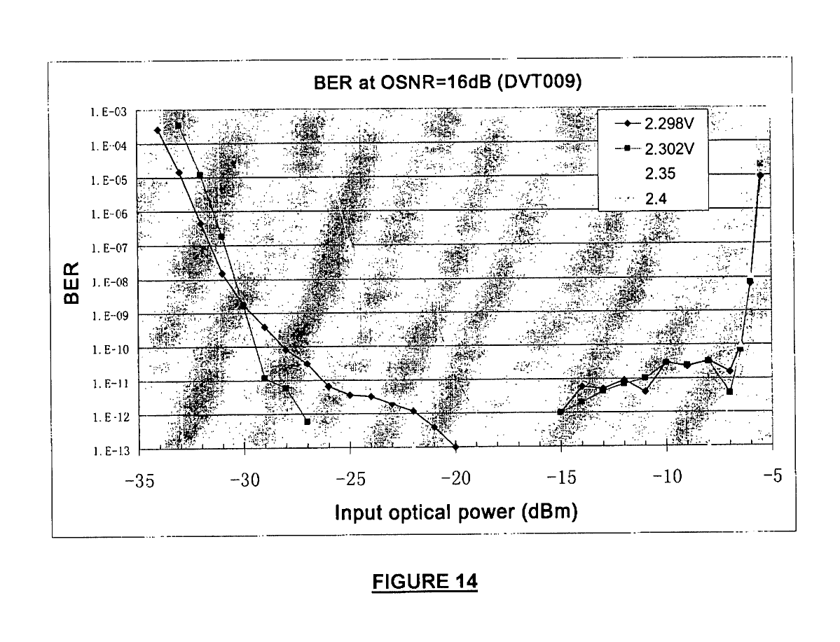

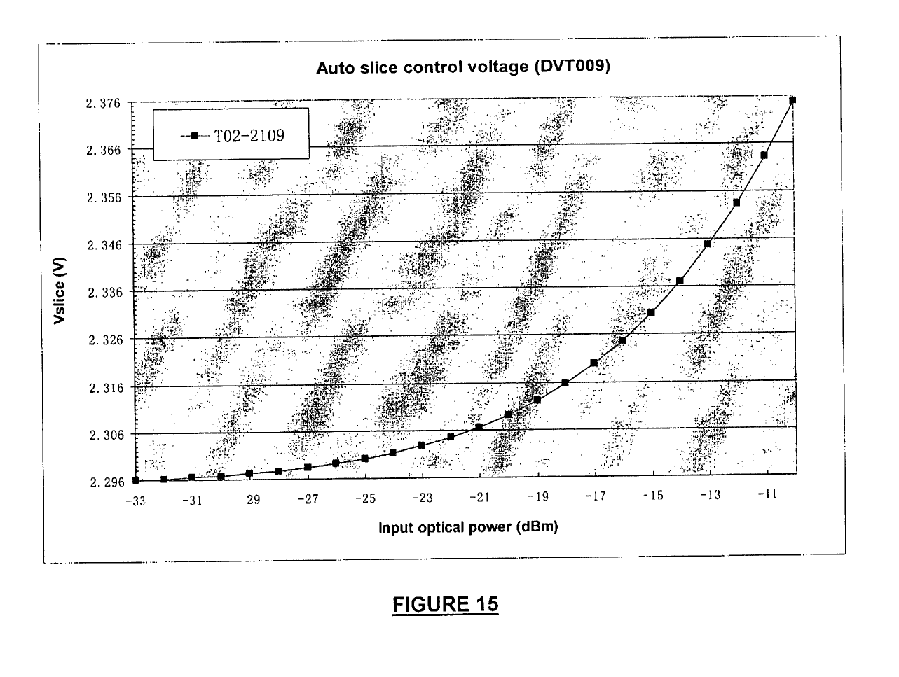

FIG. 15 shows the slice level control voltage versus input optical power for the above equation implemented in a receiver module. The scaling factor K used in this algorithm is 4 mV. 2.296V is the optimum slice control voltage at Pin=−33 dBm]. For low input signal levels (from −33 dBm to −27 dBm) the change of slice voltage is small (˜2 mV). This gives a minimum penalty under normal operating conditions (i.e. with a clean signal). The slice level control voltage increased by around 6mV when the input signal level is close to −22 dBm (sensitivity specification for OSNR=16 dB). The slice control voltage is increased by around 50 mV when the input signal increased to above −13 dBm. This introduces a higher offset to the input signal and reduces the noise floor shown in FIG. 14.

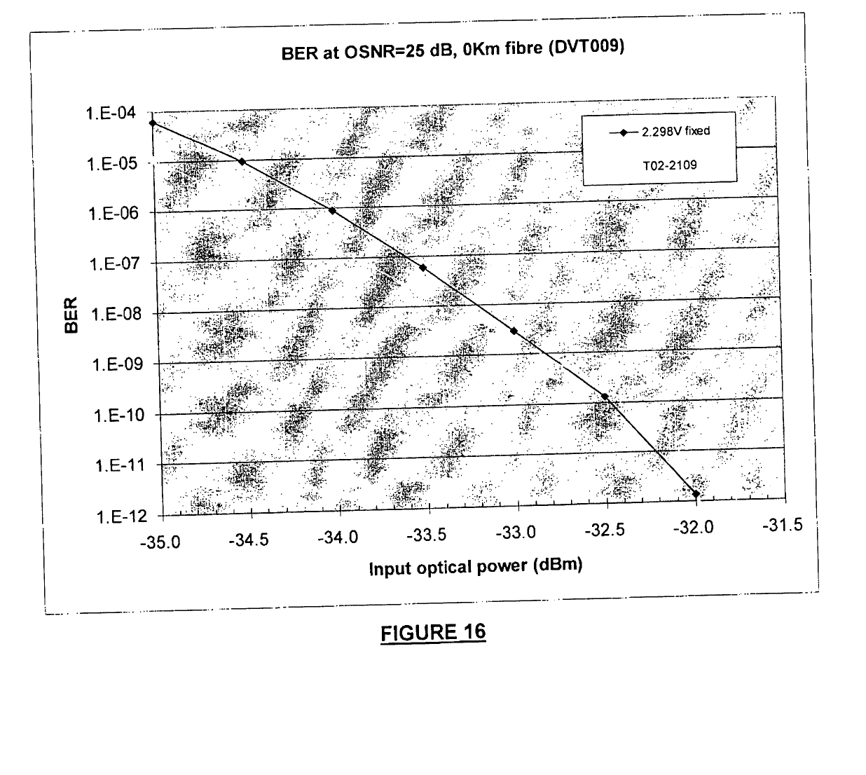

FIG. 16 shows the measured BER of the receiver module using the adaptive slice level control equation at OSNR=25 dB. The test result shows that the change of sensitivity with a fixed slice control voltage (2.296V) and automatic slice control is very small (˜0.2 dB) in applications with low optical noise and low dispersion.

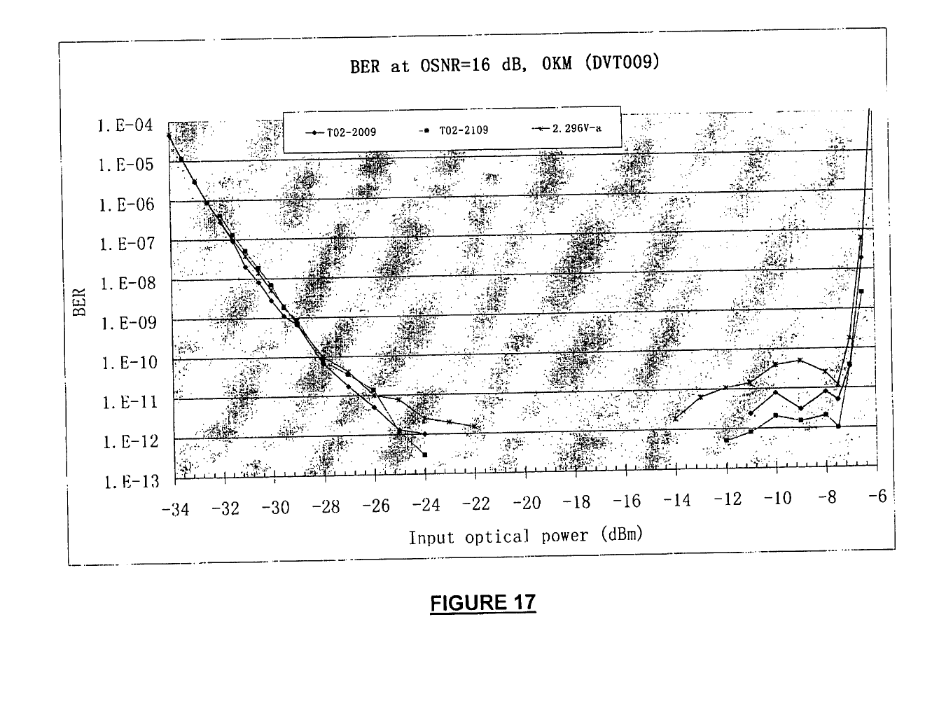

FIG. 17 shows the measured BER of the receiver module using the adaptive slice level control equation at OSNR=16 dB. The test result shows that the sensitivity of the device has been improved by around 3 dB when the automatic slice level control is enabled. The result also shows that noise floor at high input power is also pushed from −15 dBm to −11 dBm (BER≦10⁻¹²) when adaptive slice level control is enabled.

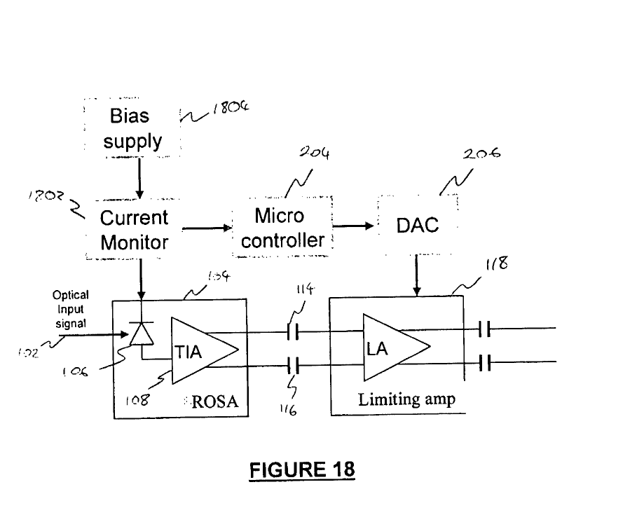

As mentioned previously with reference to FIG. 2, the adaptive slice level control can be based on either the mean input optical power to the receiver, or the peak input optical power to the receiver. FIG. 18 shows the block diagram of a slice level control circuit that measures the mean input power.

FIG. 18 is similar to the adaptive slice level control circuit of FIG. 2, except that a current monitor circuit 1802 is used between a photodiode bias supply 1804 and the photodiode 106. The current monitor circuit 1802 measures the average input photo current of the ROSA 104. This is used as a measure of the average input optical power. The measured average input current is then fed to the microprocessor 204 which sets the slice level control voltage based on the required slice level for the limiting amplifier given the input average current (for example using the equation outlined above).

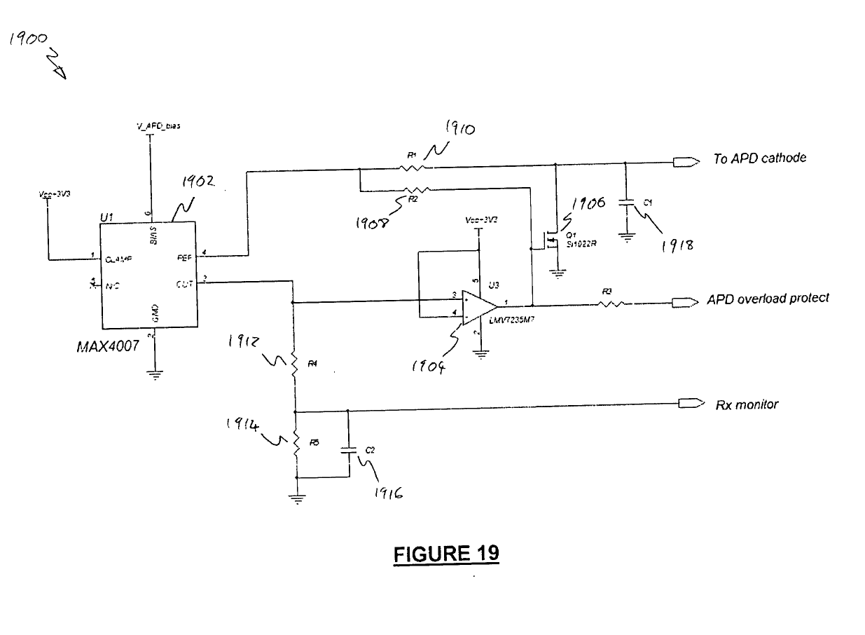

FIG. 19 shows an example of a current monitor circuit 1802 that can be used in an APD based optical receiver. The circuit 1900 comprises a current monitor integrated circuit (IC) 1902 connected to the APD bias supply (V_APD_bias) and the TIA bias supply (Vcc+3V3), a fast comparator 1904 with open drain output connected to the TIA bias supply (Vcc+3V3), a fast FET switch 1906 connected between the output of the comparator 1904 and the APD cathode, a pull up resistor 1908 for TIA protection, a serial resistor 1910 for self-latching in the APD protection mode, and current sensing resistors 1912 and 1914 for APD current monitoring. The current monitor is connected to the centre point of the resistors 1912 and 1914 and to ground by a capacitor 1916, and the APD cathode is connected to ground by a capacitor 1918.

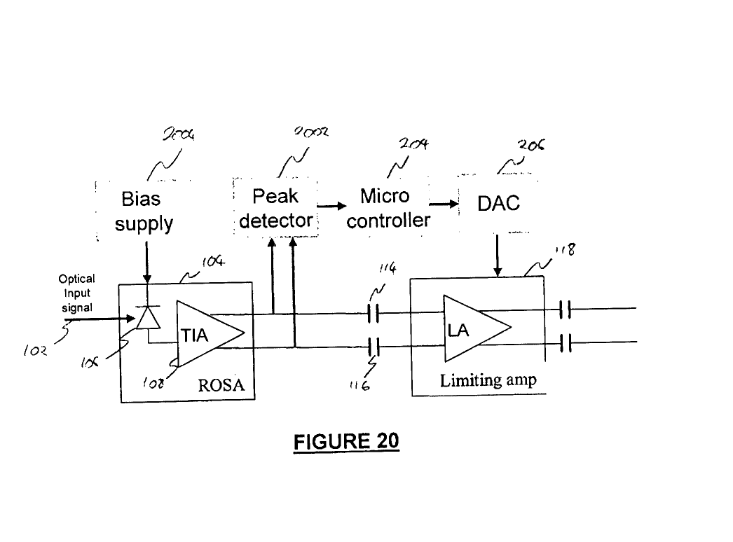

As an alternative to the mean input optical power measurement, the peak input optical power can be measured and used by the adaptive slice level control circuit. FIG. 20 shows the block diagram of a peak input power based slice level control circuit. The operation of the ROSA 104 and LA 118 section are similar to the mean power based slice level control circuit shown in FIG. 18. In the peak power based slice level control the power is measured from the output of the TIA 108. The signal from the output of the TIA 108 is provided to a peak detector circuit 2002, which measures the peak value of the signal and provides this value to the microprocessor 204. The microprocessor 204 can then use this information to determine the value of the slice level control voltage (using for example the equation shown above).

In the circuit in FIG. 20, the bias supply 2004 is provided directly to the APD 106, and is not monitored as in FIG. 18.

The advantage of using the peak input measurement (as in FIG. 20) rather than the mean input measurement (as in FIG. 18) is that it is more accurate for slice level control as all DC noise (such as from the optical amplifier) is removed by the peak detector. The disadvantage of the peak input measurement is that the signal is taken after the TIA 108, and hence the control range is limited by the linear operating range of the TIA 108.

In summary, the above-described slice level control technique has several advantageous features. For example, the slice level control is realised by utilising the DC cancellation function of the limiting amplifier, and hence there is minimum interference to the high-speed input signal. The slice level can be set either to a pre-determined value, or can be made adaptive according to the input signal level (mean or peak value). Furthermore, the number of components required to implement the slice level control is kept to a minimum, which is critical for hot-pluggable SFP and XFP modules where the board space is very tight.

Also, the slice level control technique is not implemented at the ROSA 104 stage of the module, when the optical input signal (analogue) is first converted to an electric signal (either digital or pseudo-digital), it is relatively simple to implement.

Furthermore, by using the internal DC cancellation circuitry of a limiting amplifier, it removes the possibility of the DC cancellation circuit otherwise acting to cancel any attempt to vary the slice level.

In the above-described embodiment, the micro processor and the code loaded to it (the firmware) are used to carry out signal processing, and produce the required control signal (via an D/A converter) to change the input slice level (decision level) of the amplifier.

The present invention has been described above in detail for a 2.5 Gb/s SFP module product, but it could also be used, for example, in any pluggable modules, particularly those that require optimum performance over long fibre or through many optical amplifications (hence low OSNR).

While this invention has been particularly shown and described with reference to preferred embodiments, it will be understood to those skilled in the art that various changes in form and detail may be made without departing from the scope of the invention.

More generally, the applicant draws attention to the fact that the present invention may include any feature or combination of features disclosed herein either implicitly or explicitly or any generalisation thereof, without limitation to the scope of any definitions set out above. In view of the foregoing description it will be evident to a person skilled in the art that various modifications may be made within the scope of the invention.

What is claimed is:

1. A method of processing an optical signal, including:
generating one or more electrical signals indicative of said optical signal;
applying said one or more electrical signals to one or more input pins of a chip configured to generate an output indicative of a comparison of the level of said one or more electrical signals with a reference level, the chip including circuitry configurable via two control pins to function as a DC offset cancellation loop; and
applying across said two control pins a potential difference dependent on a characteristic of said optical signal so as to control said reference level in dependence on said characteristic of said optical signal.

2. A method according to claim 1, wherein said chip includes circuitry configured to function as a DC offset cancellation loop if a capacitor is connected between said two control pins.

3. A system for processing an optical signal, including:
an optical detector unit configured to generate one or more electrical signals indicative of said optical signal;
a chip arranged to receive said one or more electrical signals at one or more input pins thereof and configured to generate an output indicative of a comparison of the level of said one or more electrical signals with a reference level, the chip including circuitry configurable via two control pins to function as a DC offset cancellation loop; and
a control unit configured to apply across said two control pins a potential difference dependent on a characteristic of said optical signal so as to control said reference level in dependence on said characteristic of said optical signal.

4. A control unit for controlling the processing of an optical signal, wherein the control unit is configured to control in dependence on a characteristic of said optical signal the magnitude of a potential difference applied across two control pins of a chip for receiving at one or more input pins thereof one or more electrical signals indicative of said optical signal and generating an output indicative of a comparison of the level of said one or more electrical signals with a reference level, the chip including circuitry configurable via said two control pins to function as a DC offset cancellation loop.

5. A computer program product comprising program code means which when loaded into a computer controls the computer to carry out the step of claim 1 of controlling the potential difference across said two control pins of said chip in dependence on a characteristic of said optical signal.

6. A method of processing an optical signal, including:
generating one or more electrical signals indicative of said optical signal;
applying said one or more electrical signals to one or more input pins of a chip configured to generate an output indicative of a comparison of the level of said one or more electrical signals with a reference level, the chip including circuitry configurable via two control pins to function as a DC offset cancellation loop; and
actively varying the potential difference across said two control pins in order to control said reference level.
